(19) United States
(12) Patent Application Publication
(10) Pub. No.: US 2026/0221341 A1
(43) Pub. Date: Jul. 30, 2026

(54) MULTILAYER CERAMIC ELECTRONIC DEVICE AND DIELECTRIC CERAMIC COMPOSITION

(71) Applicant: TAIYO YUDEN CO., LTD., Tokyo (JP)

(72) Inventor: Kotaro OHASHI, Takasaki-shi (JP)

(21) Appl. No.: 19/442,756

(22) Filed: Jan. 7, 2026

(30) Foreign Application Priority Data
Jan. 29, 2025 (JP) 2025-013166

(51) Int. Cl. H01G 4/12; H01G 4/232; H01G 4/30

(52) U.S. Cl. CPC H01G 4/1254; H01G 4/1227; H01G 4/232; H01G 4/30

(57) ABSTRACT

A multilayer ceramic electronic device includes a dielectric layer of which a main component is a dielectric ceramic composition represented by a formula (BiₐNa_{b}M_{c})(Ti_{d}NbₑN_{f})O₃, where M is at least one element selected from La, Ce, Pr, Nd, Sm, Eu, Gd, Tb, Dy, Ho, Yb, Y, Bi, Ba, Sr, Mg, and Ca, and N is at least one element selected from Mn, V, Fe, W, and Mo, and where following conditions 0.1<a<0.5, 0.4<b<0.8, 0<c≤0.2, 0.4<d<0.8, 0.2<e<0.5, 0<f≤0.1, 0.90≤a+b+c≤1.05 and 0.90≤d+e+f≤1.05 are satisfied, a plurality of internal electrode layers sandwiching the dielectric layer and facing each other, and a plurality of external electrodes, each of which is electrically connected to teach of the plurality of internal electrode layers.

### CROSS-REFERENCE TO RELATED APPLICATION

This application is based upon and claims the benefit of priority of the prior Japanese Patent Application No. 2025-013166, filed on Jan. 29, 2025, the entire contents of which are incorporated herein by reference.

### FIELD

A certain aspect of the present disclosure relates to a multilayer ceramic electronic device and a dielectric ceramic composition.

### BACKGROUND

In high-frequency communication systems, such as mobile phones, multi-layer ceramic electronic devices such as multi-layer ceramic capacitors (MLCCs) (see, for example, Japanese Patent Application Publication No. 2016-60647 hereinafter referred to as Patent Document 1 and Japanese Patent Application Publication No. 2016-56058 hereinafter referred to as Patent Document 2) are used to eliminate noise. In particular, in the field of power electronics, there is a demand for capacitors that can operate under high temperatures and high voltages for applications such as stable power supply, motor drive control, and power conversion devices. With the increasing popularity of electric vehicles and other vehicles, this demand is expected to increase further. Required characteristics include a high dielectric constant when a high DC bias is applied, as well as a long high-temperature load life. Furthermore, there is a demand for capacitors that do not change dielectric constant over a wide temperature range.

### SUMMARY OF THE INVENTION

According to an aspect of the embodiments, there is provided a multilayer ceramic electronic device including: a dielectric layer of which a main component is a dielectric ceramic composition represented by a formula (BiₐNa_{b}M_{c})(Ti_{d}NbₑN_{f})O₃, where M is at least one element selected from La, Ce, Pr, Nd, Sm, Eu, Gd, Tb, Dy, Ho, Yb, Y, Bi, Ba, Sr, Mg, and Ca, and Nis at least one element selected from Mn, V, Fe, W, and Mo; and where following conditions are satisfied: 0.1<a<0.5; 0.4<b<0.8; 0<c≤0.2; 0.4<d<0.8; 0.2<e<0.5; 0<f≤0.1; 0.90≤a+b+c≤1.05; and 0.90≤d+e+f≤1.05; a plurality of internal electrode layers sandwiching the dielectric layer and facing each other; and a plurality of external electrodes, each of which is electrically connected to teach of the plurality of internal electrode layers.

According to another aspect of the embodiments, there is provided a dielectric ceramic composition including: a material represented by a formula (BiₐNa_{b}M_{c})(Ti_{d}NbₑN_{f})O₃, where M is at least one element selected from La, Ce, Pr, Nd, Sm, Eu, Gd, Tb, Dy, Ho, Yb, Y, Bi, Ba, Sr, Mg, and Ca, and Nis at least one element selected from Mn, V, Fe, W, and Mo, and where following conditions are satisfied: 0.1<a<0.5; 0.4<b<0.8; 0<c≤0.2; 0.4<d<0.8; 0.2<e<0.5; 0<f≤0.1; 0.90≤a+b+c≤1.05; and 0.90≤d+e+f≤1.05.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4A and FIG. 4B are enlarged cross-sectional views of vicinity of an external electrode;

FIG. 5 is a schematic cross-sectional view of a dielectric layer;

FIG. 6 is a diagram illustrating a unit lattice of a dielectric ceramic composition having a perovskite structure;

FIG. 7 is a diagram illustrating effects of an additive element N;

FIG. 8A to FIG. 8C are enlarged cross sectional views around dielectric grains;

FIG. 9 illustrates a flow of a manufacturing method of a multilayer ceramic capacitor;

FIG. 10A and FIG. 10B illustrate a printing process; and

FIG. 11 illustrates a crimping process.

### DETAILED DESCRIPTION

In Patent Document 1, the relative dielectric constant when a DC bias is applied is improved by adding a rare earth element to a mixed material of (Bi,Na)TiO₃ and SrTiO₃. However, no mention is made of high-temperature load life. In Patent Document 2, a tungsten bronze-type composite oxide material is used to achieve good high-temperature load life, but the relative dielectric constant is a low value of around 200.

Hereinafter, an exemplary embodiment will be described with reference to the accompanying drawings.

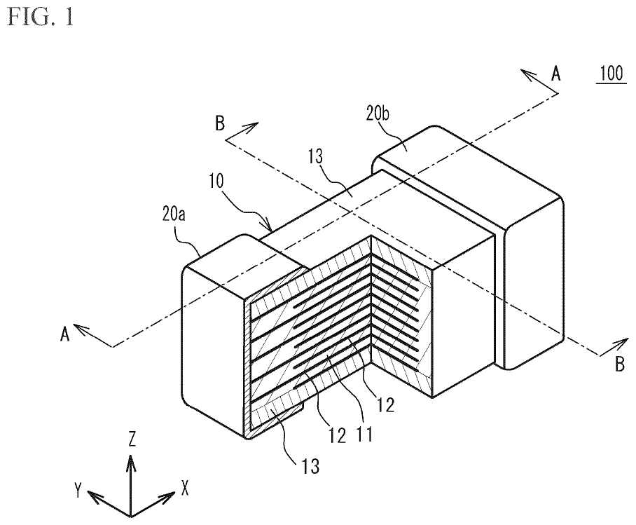

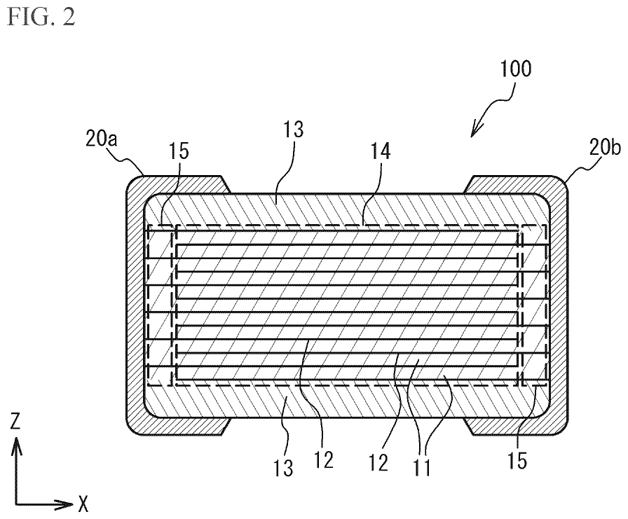

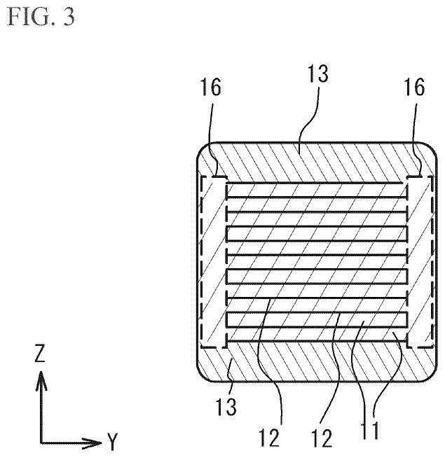

(Embodiment) FIG. 1 illustrates a perspective view of a multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes an element body 10 having a rectangular parallelepiped shape, and external electrodes 20a and 20b that are respectively provided on two end faces of the element body 10 facing each other. Among four faces other than the two end faces of the element body 10, two faces other than the upper face and the lower face in the stacking direction are referred to as side faces. Each of the external electrodes 20a and 20b extends to the upper face and the lower face in the stacking direction and the two side faces of the element body 10. However, the external electrodes 20a and 20b are spaced from each other.

In FIG. 1 to FIG. 3, the Z-axis direction (first direction) is the stacking direction, and is the direction in which the internal electrode layers face each other. The X-axis direction (second direction) is the length direction of the element body 10, and is the direction in which the two end faces of the element body 10 face each other, and in which the external electrodes 20a and 20b face each other. The Y-axis direction (third direction) is the width direction of the internal electrode layers, and is the direction in which the two side faces other than the two end faces of the four side faces of the element body 10 face each other. The X-axis direction, Y-axis direction, and Z-axis direction are orthogonal to each other.

The element body 10 has a structure designed to have dielectric layers 11 (dielectric ceramic composition) and internal electrode layers 12 alternately stacked. The dielectric layer 11 contains a ceramic material acting as a dielectric material. End edges of the internal electrode layers 12 are alternately exposed to a first end face of the element body 10 and a second end face of the element body 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11. Note that the configuration is not limited to those illustrated in FIGS. 1 to 3, as long as the internal electrode layers 12 are exposed on two different surfaces and are electrically connected to different external electrodes.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The internal electrode layers 12 are primarily composed of silver (Ag), silver-palladium (Pd) alloy, platinum (Pt), or the like. The thickness of the internal electrode layers 12 is, for example, 0.1 μm or more and 3.0 μm or less, 0.1 μm or more and 2.5 μm or less, or 0.1 μm or more and 2.0 μm or less. The thickness of the internal electrode layers 12 can be measured by observing the cross section of the multilayer ceramic capacitor 100 with a scanning electron microscope (SEM), measuring the thickness at 10 points for each of the 10 different internal electrode layers 12, and deriving the average value of all the measurement points.

The dielectric layer 11 is primarily composed of a dielectric ceramic composition (ceramic material) with a perovskite structure represented by the general formula ABO₃. This perovskite structure includes ABO_{3-α}, which deviates from the stoichiometric composition. The dielectric ceramic composition used is represented by (BiₐNa_{b}M_{c})(Ti_{d}NbₑN_{f})O₃. Bi is bismuth, Na is sodium, Ti is titanium, Nb is niobium, and O is oxygen. M is an additive element and is at least one selected from La (lanthanum), Ce (cerium), Pr (praseodymium), Nd (neodymium), Sm (samarium), Eu (europium), Gd (gadolinium), Tb (terbium), Dy (dysprosium), Ho (holmium), Yb (ytterbium), Y (yttrium), Bi (bismuth), Ba (barium), Sr (strontium), Mg (magnesium), and Ca (calcium). Nis an additive element and is at least one selected from Mn (manganese), V (vanadium), Fe (iron), W (tungsten), and Mo (molybdenum). The following conditions are satisfied: 0.1<a<0.5, 0.4<b<0.8, 0<c≤0.2, 0.4<d<0.8, 0.2<e<0.5, 0<f≤0.1, 0.90≤a+b+c≤1.05, and 0.90≤d+e+f≤1.05. For example, the dielectric layers 11 contain the above-mentioned dielectric ceramic composition at 90 at % or more. The thickness of the dielectric layers 11 is, for example, 1 μm or more and 100 μm or less, 2 μm or more and 60 μm or less, or 3 μm or more and 50 μm or less. The thickness of the dielectric layers 11 can be measured by observing the cross section of the multilayer ceramic capacitor 100 with a scanning electron microscope (SEM), measuring the thickness at 10 points for each of the 10 different dielectric layers 11, and deriving the average value of all the measurement points.

The dielectric layer 11 may contain an additive. The additive is such as an oxide of zirconium (Zr), hafnium (Hf), magnesium (Mg), manganese (Mn), molybdenum (Mo), vanadium (V), chromium (Cr), barium (Ba), strontium (Sr), calcium (Ca), or a rare earth element (yttrium (Y), samarium (Sm), europium (Eu), gadolinium (Gd), terbium (Tb), dysprosium (Dy), holmium (Ho), erbium (Er), thulium (Tm), or ytterbium (Yb)), an oxide containing cobalt (Co), nickel (Ni), lithium (Li), boron (B), potassium (K), or silicon (Si), or a glass containing cobalt, nickel, lithium, boron, sodium, potassium, or silicon.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the element body 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

In the YZ cross section, the cover layer 13 and the side margins 16 form the outer periphery of the capacity section 14. Therefore, hereinafter, the portion forming the outer periphery of the capacity section 14 in the YZ cross section may be collectively referred to as the outer periphery. Note that the cover layer 13 refers to the portion of the outer periphery in the YZ cross section that is above the uppermost internal electrode layer 12 in the Y-axis direction. Therefore, the capacity section 14 and the pair of side margins are sandwiched between the two cover layers 13.

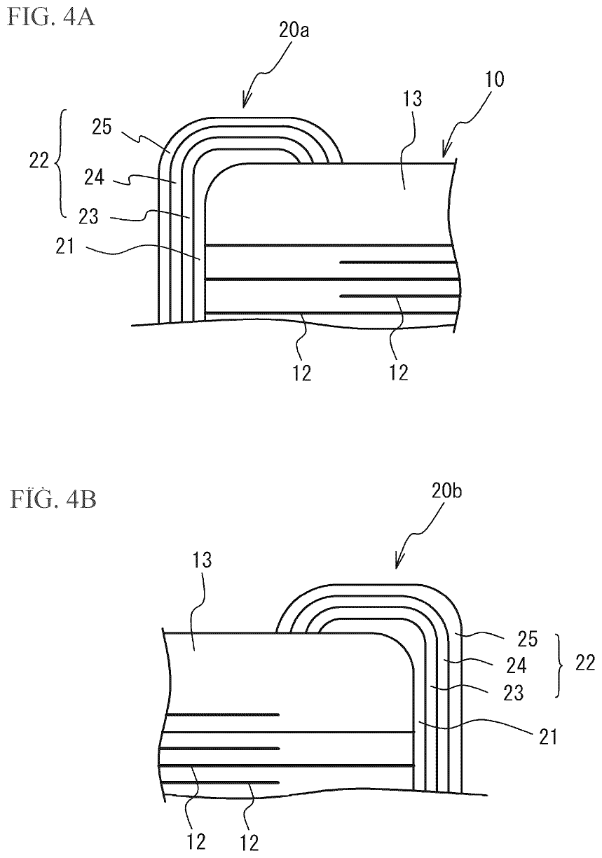

FIG. 4A is an enlarged cross-sectional view of the vicinity of the external electrode 20a. FIG. 4B is an enlarged cross-sectional view of the vicinity of the external electrode 20b. Hatching is omitted in FIG. 4A and FIG. 4B. As illustrated in FIG. 4A and FIG. 4B, the external electrodes 20a, 20b have a structure in which a plated layer 22 is provided on a base layer 21. The base layer 21 is primarily composed of silver, a silver-palladium alloy, platinum, or the like. The base layer 21 may also contain a glass component. The plated layer 22 is primarily composed of a metal such as nickel, copper, aluminum, zinc, or tin, or an alloy of two or more of these metals. The plated layer 22 may be composed of a single metal component, or multiple plated layers composed of different metal components. For example, the plated layer 22 has a structure in which, from the base layer 21 side, a first plated layer 23, a second plated layer 24, and a third plated layer 25 are formed. The first plated layer 23 is, for example, a copper plated layer, the second plated layer 24 is, for example, a nickel plated layer, and the third plated layer 25 is, for example, a tin plated layer.

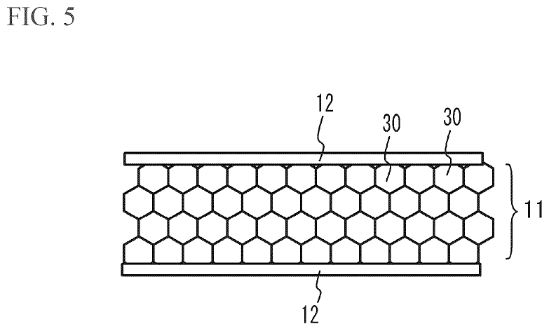

FIG. 5 is a schematic cross-sectional view of the dielectric layer 11. As illustrated in FIG. 5, the dielectric layer 11 has a structure in which a plurality of dielectric grains 30 constituting the main phase are sintered. For example, the dielectric layer 11 may have a single dielectric grain 30 in the thickness direction, or may have a structure in which the multiple dielectric grains 30 are connected via grain boundaries, as illustrated in FIG. 5. The dielectric grain 30 is a crystalline grain of the dielectric ceramic composition that is the main component of the dielectric layer 11 described above.

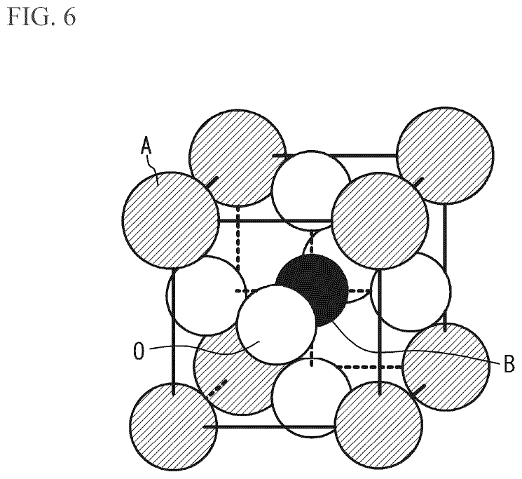

FIG. 6 is a diagram illustrating a unit lattice of a dielectric ceramic composition having a perovskite structure. This unit lattice contains A sites located at the lattice vertices, O sites located at the lattice face centers, and B sites located within octahedra with the O sites as vertices. In the perovskite structure, alkaline earth metals that can become divalent cations tend to form solid solutions in the A site, and metal atoms that can become tetravalent cations tend to form solid solutions in the B site. In this embodiment, bismuth, sodium, and the additive element M form a solid solution at the A site, and titanium, niobium, and the additive element N form a solid solution at the B site.

The lattice constant of (BiₐNa_{b}M_{c})(Ti_{d}NbₑN_{f})O₃ used in this embodiment can range from 3.2 Å to 4.8 Å.

In this embodiment, a ceramic with a (BiNa)(TiNb)O₃-based perovskite structure represented by (BiₐNa_{b}M_{c})(Ti_{d}NbₑN_{f})O₃ is used as the main ceramic component of the dielectric layer 11. This enables the dielectric constant to be maintained high when a DC bias is applied, while suppressing changes in the dielectric constant over a wide temperature range.

Next, the effects of the additive elements N and M will be described. The ionic radii of manganese, vanadium, iron, tungsten, and molybdenum that can be used as the additional element N are Mn: 0.58 Å, V: 0.54 Å, Fe: 0.55 Å, W: 0.60 Å, and Mo: 0.59 Å, respectively. From the viewpoint of ionic radius, these additional elements N can form a substitutional solid solution in the B site of (BiNa)(TiNb)O₃-based perovskite.

The ionic radii of lanthanum, cerium, praseodymium, neodymium, samarium, europium, gadolinium, terbium, dysprosium, holmium, ytterbium, yttrium, bismuth, barium, strontium, magnesium, and calcium that can be used as additive elements M are as follows: La: 1.36 Å, Ce: 1.34 Å, Pr: 1.30 Å, Nd: 1.27 Å, Sm: 1.24 Å, Eu: 1.22 Å, Gd: 1.21 Å, Tb: 1.20 Å, Dy: 1.19 Å, Ho: 1.18 Å, Yb: 1.16 Å, Y: 1.22 Å, Bi: 1.38 Å, Ba: 1.61 Å, Sr: 1.44 Å, Mg: 0.89 Å, and Ca: 1.34 Å. From the perspective of ionic radius, these additive elements N can form a substitutional solid solution in the A site of (BiNa)(TiNb)O₃-based perovskite.

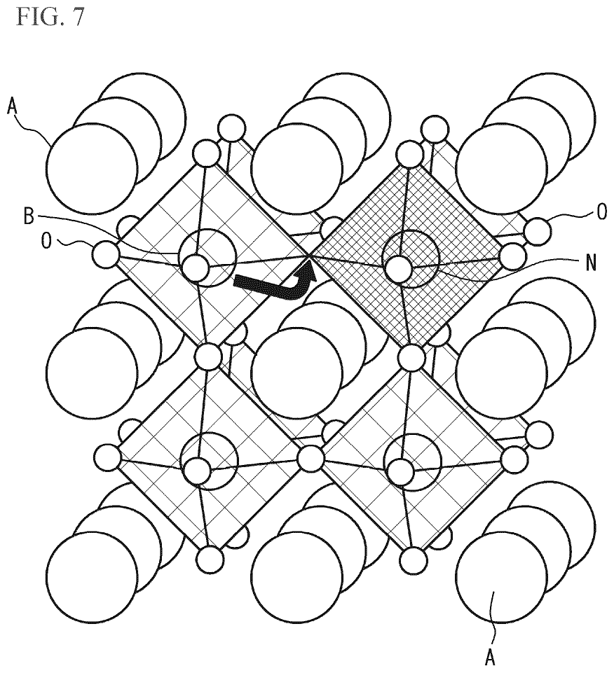

FIG. 7 is a diagram illustrating the effects of the additive element N. Through diligent research by the inventors, it has been discovered that the additive element N forms a solid solution in the B site of the perovskite structure, energetically stabilizing complex defects with oxygen vacancies. Even at high temperatures, the additive element N solid-solution in the B site does not migrate due to an electric field, and oxygen vacancies are also bound by the additive element N, suppressing migration as indicated by the arrows in FIG. 7. Since failures during high-temperature loading are caused by oxygen vacancies migrating toward the cathode, the additive element N can improve high-temperature loaded life by suppressing oxygen vacancy migration.

However, further research by the inventors has revealed that: simply adding the additive element N introduces oxygen vacancies; and these oxygen vacancies then diffuse during sintering, promoting element diffusion and inducing abnormal grain growth. When abnormal grain growth occurs, the number of grain boundaries that suppress oxygen vacancy migration decreases. This cancels out the effects of the grain interior and grain boundaries, resulting in little improvement in high-temperature load life. Mechanical strength also decreases.

Therefore, adding the additive element M with a valence of 2 or more that solid-dissolves in the A site from the perspective of ionic radius is equivalent to donor doping to sodium, shifting the charge balance of the system toward the electron-rich side. Shifting the charge balance of the system toward the electron-rich side suppresses the formation of oxygen vacancies and suppresses abnormal grain growth caused by the addition of the additive element N.

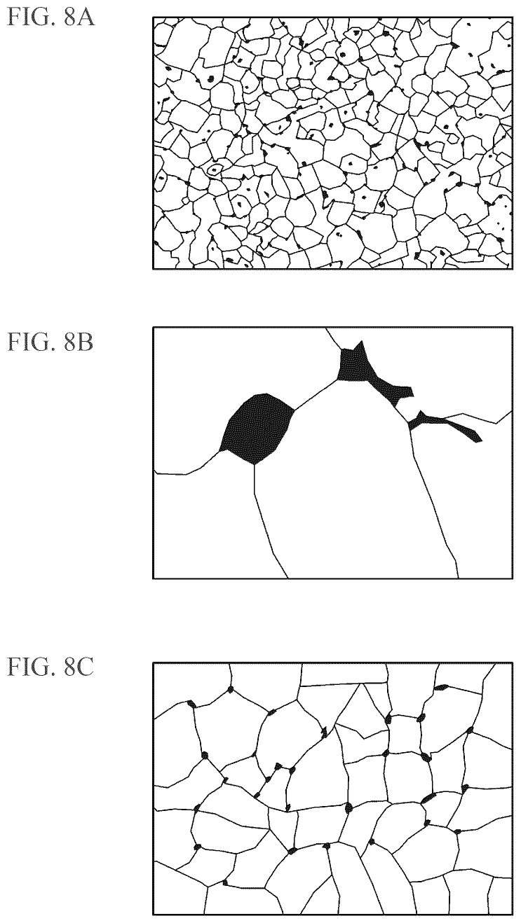

FIG. 8A to FIG. 8C are cross-sectional SEM images of sintered bodies with and without the additive elements M and N. FIG. 8A is an SEM image when neither the additive element M nor the additive element N is added. FIG. 8B is an SEM image when only the additive element N is added but not the additive element M. FIG. 8C is an SEM image when both the additive element M and the additive element N are added. It can be seen that when only the additive element Nis added, grain growth is significant compared to when neither the additive element M nor the additive element N is added. It can also be seen that grain growth is suppressed by adding the additive element N as well as the additive element M.

From the above, this embodiment maintains a high relative dielectric constant when a DC bias is applied, while exhibiting a good high-temperature accelerated lifetime and suppressing changes in the dielectric constant over a wide temperature range. Furthermore, by suppressing abnormal grain growth, mechanical strength is also improved.

In order to maintain a high relative dielectric constant when a DC bias is applied, exhibit a good high-temperature accelerated lifetime, and suppress changes in the dielectric constant over a wide temperature range, a balance of the composition ratios of (BiₐNa_{b}M_{c})(Ti_{d}NbₑN_{f})O₃ is required. Through extensive research, the inventors have identified the following ranges: 0.1<a<0.5, 0.4<b<0.8, 0<c≤0.2, 0.4<d<0.8, 0.2<<0.5, 0<f≤0.1, 0.90≤a+b+c≤1.05, and 0.90≤d+e+f≤1.05. The composition of the dielectric grain 30 (excluding sodium) can be analyzed using inductively coupled plasma mass spectrometry (ICP-MS). Sodium can be quantitatively evaluated using inductively coupled plasma atomic emission spectrometry (ICP-AES).

In order to maintain good DC bias characteristics, it is preferable that (BiₐNa_{b}M_{c})(TiₐNbₑN_{f})O₃ satisfy the following conditions: 0<c≤0.1, and 0<f≤0.05. In addition, in order to maintain good DC bias characteristics, it is preferable that (BiₐNa_{b}M_{c})(Ti_{d}NbₑN_{f})O₃ satisfy the following conditions: 0.2<a<0.4, 0.5<b<0.7, 0<c≤0.05, 0.5<d<0.7, 0.25<e<0.45, and 0<f≤0.05.

The average grain size of the dielectric grains 30 in the dielectric layer 11 is preferably 0.05 μm or more and 10 μm or less, more preferably 0.1 μm or more and 5 μm or less, and even more preferably 0.2 μm or more and 2 μm or less. The average grain size of the dielectric grains 30 can be measured by identifying 300 or more grains in a cross-sectional SEM photograph and taking the average of their maximum diameters.

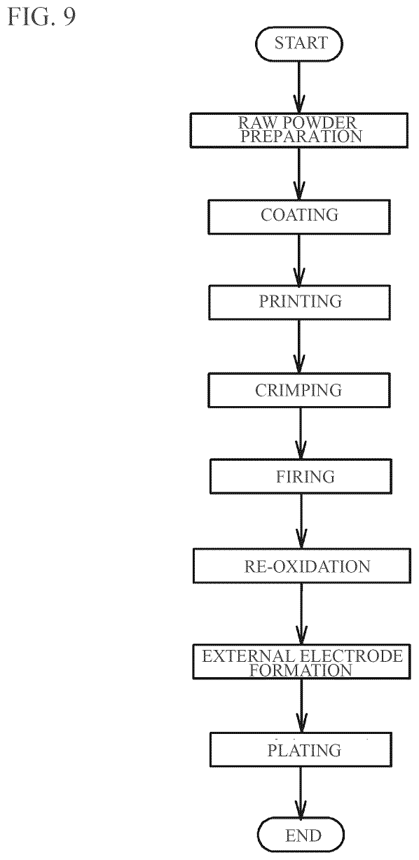

Next, a description will be given of a manufacturing method of the multilayer ceramic capacitors 100. FIG. 9 illustrates a manufacturing method of the multilayer ceramic capacitor 100.

(Raw Powder Preparation Process) First, the dielectric material for forming the dielectric layer 11 is prepared. The dielectric material is a powder containing bismuth, sodium, titanium, niobium, the additive element M, and the additive element N. Each component is weighed according to the following formula: (BiₐNa_{b}M_{c})(Ti_{d}NbₑN_{f})O₃. a, b, c, d, e, and f are weighed so that they fall within the following ranges: 0.1<a<0.5, 0.4<b<0.8, 0<c≤0.2, 0.4<d<0.8, 0.2<e<0.5, 0<f≤0.1, 0.90≤a+b+c≤1.05, and 0.90≤d+e+f≤1.05, respectively.

The resulting barium titanate powder is then doped with a specific additive compound depending on the intended purpose to produce the dielectric material, cover material, and reverse pattern material. An additive compound is such as an oxide of zirconium, hafnium, magnesium, manganese, molybdenum, vanadium, chromium, or a rare earth element (yttrium, samarium, europium, gadolinium, terbium, dysprosium, holmium, erbium, thulium, or ytterbium), an oxide containing cobalt, nickel, lithium, boron, sodium, potassium, or silicon, or a glass containing cobalt, nickel, lithium, boron, sodium, potassium, or silicon.

(Coating Process) A binder such as polyvinyl butyral (PVB) resin, an organic solvent such as ethanol or toluene, and a plasticizer are added to the dielectric material and wet-mixed. The resulting slurry is then applied to a substrate, for example, by die coating or doctor blade, to form a dielectric green sheet 51, which is then dried. The substrate is, for example, a polyethylene terephthalate (PET) film.

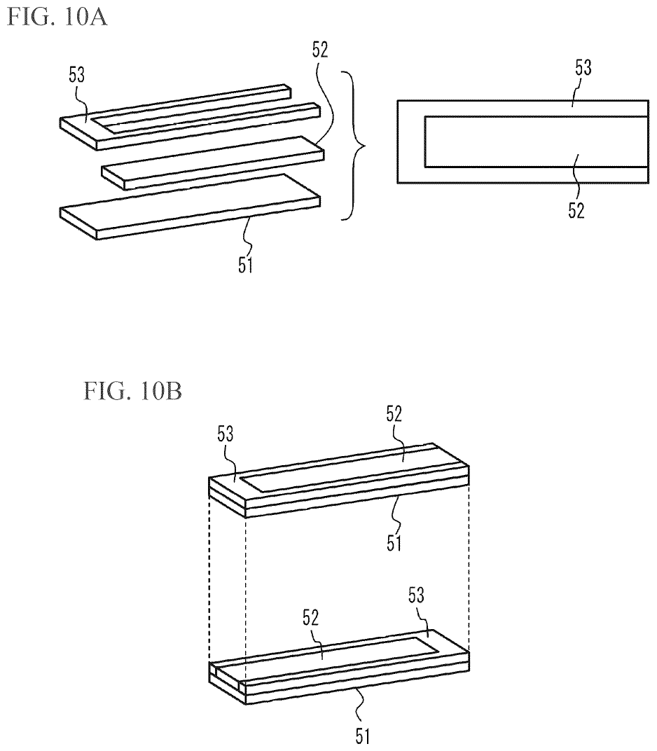

(Printing Process) Next, as illustrated in FIG. 10A, a metal conductive paste containing an organic binder for forming internal electrodes is printed on the surface of the dielectric green sheet 51 by screen printing, gravure printing, or other printing method, to form an internal electrode pattern 52 that alternately leads to a pair of external electrodes with opposite polarities. Ceramic particles are added to the metal conductive paste as a co-material. The main component of the ceramic particles is not particularly limited, but it is preferably the same as the main ceramic component of the dielectric layer 11.

Next, a binder such as an ethyl cellulose-based binder and an organic solvent such as a terpineol-based binder are added to the reverse pattern material and kneaded in a roll mill to obtain a reverse pattern paste. As illustrated in FIG. 10A, the reverse pattern paste is printed on the peripheral areas of the dielectric green sheet 51 where the internal electrode pattern 52 is not printed, thereby forming a reverse pattern 53 and filling in any gaps with the internal electrode pattern 52. The dielectric green sheet 51 on which the internal electrode pattern 52 and the reverse pattern 53 are printed is referred to as a stack unit. The above-mentioned dielectric materials may be used as materials for the reverse pattern 53.

Then, as illustrated in FIG. 10B, the stack units are stacked so that the internal electrode layers 12 and the dielectric layers 11 alternate, and so that the edges of the internal electrode layers 12 are alternately exposed at both longitudinal end faces of the dielectric layer 11 and alternately drawn out to the pair of external electrodes 20a, 20b of opposite polarity. For example, the number of layers of the internal electrode patterns 52 is set to 100 to 1000.

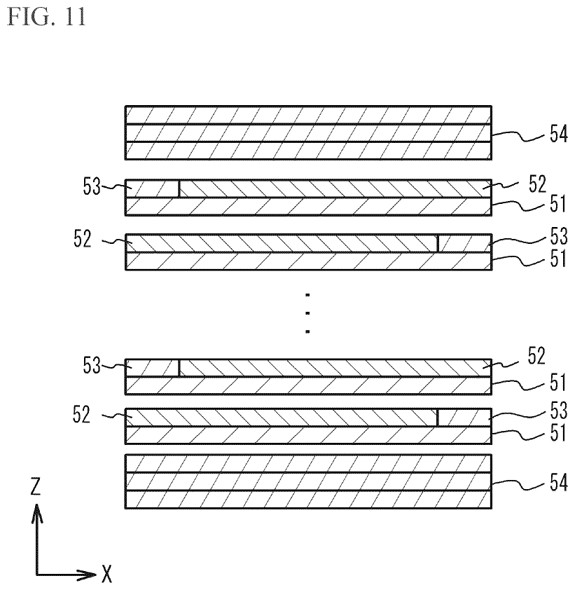

(Crimping process) Next, a binder such as an ethyl cellulose-based binder and an organic solvent such as a terpineol-based binder are added to the cover material and kneaded in a roll mill to obtain a cover sheet 54. The above-mentioned dielectric materials can be used as the cover material. As illustrated in FIG. 11, a predetermined number of the cover sheets 54 are stacked on top and bottom of the multilayer body of the stacked stack units and thermocompressed. The multilayer body is then cut to the specified chip dimensions (for example, 1.0 mm×0.5 mm).

(Firing process) Thereafter, the binder is removed in an N₂ atmosphere, and then the mixture is fired in the air at a temperature range of 900° C. to 1150° C. for 5 minutes to 10 hours.

(Re-oxidation process) Thereafter, a re-oxidation process may be performed in an N₂ gas atmosphere at 600 to 1000° C. With the processes, the element body 10 is fabricated.

(External electrode formation process) Next, a metal paste containing the metal for the base layer 21 of the external electrodes 20a and 20b is applied to the two end faces of the element body 10 obtained in this manner by dipping and then baked.

(Plating process) After that, metal layers such as copper, nickel, and tin may be formed on the base layer by plating. Thus, the multilayer ceramic capacitor 100 is manufactured.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### EXAMPLES

(Example 1) The following multilayer ceramic capacitors according to the embodiment were fabricated and their characteristics were investigated. Bismuth, sodium, titanium, niobium, the additive element M, and the additive element N were prepared as starting materials. The raw material powder was weighed according to the Formula (1). a, b, c, d, e, and f were weighed so that they were within the ranges of 0.1<a<0.5, 0.4<b<0.8, 0<c≤0.2, 0.4<d<0.8, 0.2<e<0.5, 0<f≤0.1, 0.90≤a+b+c≤1.05, and 0.90≤d+e+f≤1.05, respectively. In Example 1, lanthanum was used as the additive element M, manganese was used as the additive element N, and a was set to 0.30, b to 0.65, c to 0.05, d to 0.65, e to 0.30, and f to 0.05.

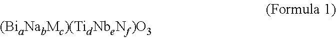

The weighed powder was subjected to a wet ball milling process using ethanol and zirconia beads to produce a raw material powder mixture. A binder such as polyvinyl butyral (PVB) resin, an organic solvent such as ethanol or toluene, and a plasticizer were added to the resulting mixture and wet-mixed. Using the resulting slurry, a ceramic green sheet was coated onto a substrate and dried. A polyethylene terephthalate (PET) film was used as the substrate. An internal electrode pattern for the internal electrode layer was formed by screen printing or other printing method using a metal conductive paste containing an organic binder on the surface of the ceramic green sheet. A silver-palladium alloy was used for the metal conductive paste. The stack units were stacked so that the internal electrode layers and dielectric layers were alternately stacked, and the internal electrode layers were alternately exposed at both longitudinal end faces of the dielectric layer, leading to a pair of external electrodes with opposite polarities. The number of layers of the internal electrode pattern was 10. A predetermined number of cover sheets were stacked on the top and bottom of the multilayer body of the stack units and thermally bonded. The ceramic multilayer body thus obtained was subjected to binder removal treatment in a N₂ atmosphere, and then fired in air at a temperature range of 900° C. to 1150° C. for 5 minutes to 10 hours.

(Example 2) In Example 2, ytterbium was used as the additive element M, manganese was used as the additive element N, and a was set to 0.30, b was set to 0.65, c was set to 0.05, d was set to 0.65, e was set to 0.30, and f was set to 0.05. Other conditions were the same as in Example 1.

(Example 3) In Example 3, barium was used as the additive element M, manganese was used as the additive element N, a was set to 0.325, b was set to 0.625, c was set to 0.05, d was set to 0.65, e was set to 0.30, and f was set to 0.05. Other conditions were the same as in Example 1.

(Example 4) In Example 4, strontium was used as the additive element M, manganese was used as the additive element N, a was set to 0.325, b was set to 0.625, c was set to 0.05, d was set to 0.65, e was set to 0.30, and f was set to 0.05. Other conditions were the same as in Example 1.

(Example 5) In Example 5, lanthanum was used as the additive element M, iron was used as the additive element N, a was set to 0.30, b was set to 0.65, c was set to 0.05, d was set to 0.65, e was set to 0.30, and f was set to 0.05. Other conditions were the same as in Example 1.

(Example 6) In Example 6, lanthanum was used as the additive element M, manganese was used as the additive element N, and a was set to 0.25, b was set to 0.65, c was set to 0.10, d was set to 0.65, e was set to 0.30, and f was set to 0.05. Other conditions were the same as in Example 1.

(Example 7) In Example 7, lanthanum was used as the additive element M, manganese was used as the additive element N, a was set to 0.20, b was set to 0.65, c was set to 0.15, d was set to 0.65, e was set to 0.30, and f was set to 0.05. Other conditions were the same as in Example 1.

(Example 8) In Example 8, lanthanum was used as the additive element M, manganese was used as the additive element N, and a was set to 0.30, b was set to 0.65, c was set to 0.05, d was set to 0.65, e was set to 0.30, and f was set to 0.10. Other conditions were the same as in Example 1.

(Comparative Example 1) In Comparative Example 1, scandium was used as the additive element M, manganese was used as the additive element N, a was set to 0.30, b was set to 0.65, c was set to 0.05, d was set to 0.65, e was set to 0.30, and f was set to 0.05. Other conditions were the same as in Example 1.

(Comparative Example 2) In Comparative Example 2, potassium was used as the additive element M, manganese was used as the additive element N, and a was set to 0.35, b was set to 0.60, c was set to 0.05, d was set to 0.65, e was set to 0.30, and f was set to 0.05. Other conditions were the same as in Example 1.

(Comparative Example 3) In Comparative Example 3, lanthanum was used as the additive element M, aluminum was used as the additive element N, and a was set to 0.30, b was set to 0.65, c was set to 0.05, d was set to 0.65, e was set to 0.30, and f was set to 0.05. Other conditions were the same as in Example 1.

(Comparative Example 4) In Comparative Example 4, the additive element M was not used, and manganese was used as the additional element N, a was set to 0.35, b was set to 0.65, c was set to 0.00, d was set to 0.65, e was set to 0.30, and f was set to 0.05. Other conditions were the same as in Example 1.

(Comparative Example 5) In Comparative Example 5, lanthanum was used as the additive element M, and manganese was used as the additive element N, a was set to 0.20, b was set to 0.60, c was set to 0.20, d was set to 0.65, e was set to 0.30, and f was set to 0.05. Other conditions were the same as in Example 1.

(Comparative Example 6) In Comparative Example 6, lanthanum was used as the additive element M, the additive element N was not used, a was set to 0.30, b was set to 0.65, c was set to 0.05, d was set to 0.70, e was set to 0.30, and f was set to 0.00. Other conditions were the same as in Example 1.

(Comparative Example 7) In Comparative Example 7, lanthanum was used as the additive element M, manganese was used as the additive element N, a was set to 0.30, b was set to 0.65, c was set to 0.05, d was set to 0.525, e was set to 0.275, and f was set to 0.20. Other conditions were the same as in Example 1.

For each sample in Examples 1 to 8 and Comparative Examples 1 to 7, electrode paste was applied to the ends using the dip method, and the DC bias characteristics of the dielectric constant, high-temperature load life, and temperature characteristics were measured. The composition of the fired multilayer ceramic capacitors was analyzed using inductively coupled plasma mass spectrometry (ICP-MS). Sodium was quantitatively evaluated using ICP atomic emission spectrometry (ICP-AES).

For DC bias characteristics, when a DC voltage of 15 V/μm was applied to the sample and an AC voltage of 1 V and 1 Hz was applied, a dielectric constant of less than 500 was judged as unacceptable (x); a value of 500 or greater was judged as fair (4); a value of 700 or greater was judged as acceptable (∘); and a value of 800 or greater was judged as excellent (double circle). In the high-temperature load life test, the sample was placed in a constant-temperature bath at 125° C. and a voltage of 15 V/μm was applied. It was judged as unacceptable (×) if the current could not be maintained at 1,000 μA or less for 10 hours or more. It was judged as acceptable (∘) if the current could be maintained at 1,000 μA or less for 10 hours or more. It was judged as excellent (double circle) if the current could be maintained at 1,000 μA or less for 100 hours or more. For temperature characteristics, it was judged as unacceptable (×) it X6S was not satisfied. It was judged as acceptable (∘) is X6S or more was satisfied. It was judged as excellent (double circle) if X7R or more was satisfied.

The results are shown in Table 1.

TABLE 1

| | | | | | | | | | | HIGH | TEMPERA- |
|---|---|---|---|---|---|---|---|---|---|---|---|
| | | | | | | | | | DC BIAS | TEMPERATURE | TURE |
| | | | | | | | | | CHARACTER- | LOAD | CHARACTER- |
| | a | b | c | M | d | e | f | N | ISTICS | LIFE | ISTICS |
| EXAMPLE 1 | 0.30 | 0.65 | 0.05 | La | 0.65 | 0.30 | 0.05 | Mn | ⊚ | ⊚ | ⊚ |
| EXAMPLE 2 | 0.30 | 0.65 | 0.05 | Yb | 0.65 | 0.30 | 0.05 | Mn | ⊚ | ⊚ | ⊚ |
| EXAMPLE 3 | 0.325 | 0.625 | 0.05 | Ba | 0.65 | 0.30 | 0.05 | Mn | ⊚ | ⊚ | ⊚ |
| EXAMPLE 4 | 0.325 | 0.625 | 0.05 | Sr | 0.65 | 0.30 | 0.05 | Mn | ⊚ | ⊚ | ⊚ |
| EXAMPLE 5 | 0.30 | 0.65 | 0.05 | La | 0.65 | 0.30 | 0.05 | Fe | ⊚ | ⊚ | ⊚ |
| EXAMPLE 6 | 0.25 | 0.65 | 0.10 | La | 0.65 | 0.30 | 0.05 | Mn | ◯ | ⊚ | ⊚ |
| EXAMPLE 7 | 0.20 | 0.65 | 0.15 | La | 0.65 | 0.30 | 0.05 | Mn | Δ | ⊚ | ⊚ |
| EXAMPLE 8 | 0.30 | 0.65 | 0.05 | La | 0.65 | 0.30 | 0.10 | Mn | ◯ | ◯ | ⊚ |
| COMPARATIVE | 0.30 | 0.65 | 0.05 | Sc | 0.65 | 0.30 | 0.05 | Mn | ◯ | X | ⊚ |
| EXAMPLE 1 | | | | | | | | | | | |
| COMPARATIVE | 0.35 | 0.60 | 0.05 | K | 0.65 | 0.30 | 0.05 | Mn | ◯ | X | ⊚ |
| EXAMPLE 2 | | | | | | | | | | | |
| COMPARATIVE | 0.30 | 0.65 | 0.05 | La | 0.65 | 0.30 | 0.05 | Al | X | X | ⊚ |
| EXAMPLE 3 | | | | | | | | | | | |
| COMPARATIVE | 0.35 | 0.65 | 0.00 | — | 0.65 | 0.30 | 0.05 | Mn | ⊚ | X | ⊚ |
| EXAMPLE 4 | | | | | | | | | | | |
| COMPARATIVE | 0.20 | 0.60 | 0.20 | La | 0.65 | 0.30 | 0.05 | Mn | X | ⊚ | ⊚ |
| EXAMPLE 5 | | | | | | | | | | | |
| COMPARATIVE | 0.30 | 0.65 | 0.05 | La | 0.70 | 0.30 | 0.00 | — | ⊚ | X | ⊚ |
| EXAMPLE 6 | | | | | | | | | | | |
| COMPARATIVE | 0.30 | 0.65 | 0.05 | La | 0.525 | 0.275 | 0.20 | Mn | ⊚ | X | ⊚ |
| EXAMPLE 7 | | | | | | | | | | | |

Examples 1 to 8 were not judged as unacceptable (×) in any of the DC bias characteristics, high-temperature load life, or temperature characteristics. This is thought to be because the dielectric layer uses a dielectric ceramic composition as its main ceramic component, which is represented as (BiₐNa_{b}M_{c})(TiₐNbₑN_{f})O₃, where the additive element M is at least one selected from La, Ce, Pr, Nd, Sm, Eu, Gd, Tb, Dy, Ho, Yb, Y, Bi, Ba, Sr, Mg, or Ca, and the additive element N is at least one selected from Mn, V, Fe, W, and Mo, and which satisfies the following conditions: 0.1<a<0.5, 0.4<b<0.8, 0<c≤0.2, 0.4<d<0.8, 0.2<e<0.5, 0<f≤0.1, 0.90≤a+b+c≤1.05, and 0.90≤d+e+f≤1.05.

Furthermore, the results of Examples 1 to 4 show that any divalent or higher element that can be solid-dissolved in the A site from the perspective of ionic radius acts as a donor dope, suppressing grain growth and thereby increasing lifespan. The results of Example 5 show that any transition metal element that can be solid-dissolved in the B site and easily changes valence forms a complex vacancy with an oxygen vacancy, thereby suppressing oxygen vacancy migration. The results of Examples 6 and 7 show that the amount c of the additional element Mis preferably 0.1 or less, and more preferably 0.05 or less. The results of Example 8 show that the amount f of the additional element N is preferably 0.05 or less.

In contrast, in Comparative Examples 1 to 7, at least one of the DC bias characteristics, high-temperature load life, and temperature characteristics was judged as unacceptable (×). In Comparative Example 1, scandium was used because its ionic radius was too small to solid-dissolve in the A site, which is thought to have prevented grain growth from being suppressed, resulting in reduced lifespan. In Comparative Example 2, it is thought that while scandium was solid-dissolved in the A site due to its ionic radius, scandium was monovalent like sodium and did not function as a donor dope, preventing grain growth from being suppressed and resulting in reduced lifespan. In Comparative Example 3, it is through that aluminum, a typical element that can be solid-dissolved in the B site but does not easily change valence, was used, and this prevented oxygen vacancy migration from being suppressed, resulting in no increase in lifespan. In Comparative Examples 4 and 5, it is thought that grain growth was not suppressed without the addition of the additive element M, and excessive addition resulted in the precipitation of secondary phases that did not contribute to the dielectric constant, which reduced the dielectric constant and degraded the DC bias. In Comparative Examples 6 and 7, it is though that when the amount of N added was too small, the function of suppressing oxygen vacancy migration did not work, resulting in a shortened life, and when the amount was too large, grains grew too much, reducing the number of grain boundaries and shortening the life.

(Example 9) In Example 9, lanthanum was used as the additive element M, and manganese was used as the additive element N, a was set to 0.30, b was set to 0.65, c was set to 0.05, d was set to 0.65, e was set to 0.30, and f was set to 0.05. Other conditions were the same as in Example 1.

(Example 10) In Example 10, lanthanum was used as the additive element M, and manganese was used as the additive element N, a was set to 0.40, b was set to 0.60, c was set to 0.05, d was set to 0.65, e was set to 0.30, and f was set to 0.05. Other conditions were the same as in Example 1.

(Example 11) In Example 11, lanthanum was used as the additive element M, and manganese was used as the additive element N, a was set to 0.20, b was set to 0.65, c was set to 0.05, d was set to 0.65, e was set to 0.30, and f was set to 0.05. Other conditions were the same as in Example 1.

(Example 12) In Example 12, lanthanum was used as the additive element M, and manganese was used as the additive element N, a was set to 0.25, b was set to 0.70, c was set to 0.05, d was set to 0.65, e was set to 0.30, and f was set to 0.05. Other conditions were the same as in Example 1.

(Example 13) In Example 13, lanthanum was used as the additive element M, and manganese was used as the additive element N, a was set to 0.35, b was set to 0.50, c was set to 0.05, d was set to 0.65, e was set to 0.30, and f was set to 0.05. Other conditions were the same as in Example 1.

(Example 14) In Example 14, lanthanum was used as the additive element M, and manganese was used as the additive element N, a was set to 0.30, b was set to 0.65, c was set to 0.05, d was set to 0.70, e was set to 0.30, and f was set to 0.05. Other conditions were the same as in Example 1.

(Example 15) In Example 15, lanthanum was used as the additive element M, and manganese was used as the additive element N, a was set to 0.30, b was set to 0.65, c was set to 0.05, d was set to 0.50, e was set to 0.40, and f was set to 0.05. Other conditions were the same as in Example 1.

(Example 16) In Example 16, lanthanum was used as the additive element M, and manganese was used as the additive element N, a was set to 0.30, b was set to 0.65, c was set to 0.05, d was set to 0.55, e was set to 0.45, and f was set to 0.05. Other conditions were the same as in Example 1.

(Example 17) In Example 17, lanthanum was used as the additive element M, and manganese was used as the additive element N, a was set to 0.30, b was set to 0.65, c was set to 0.05, d was set to 0.65, e was set to 0.25, and f was set to 0.05. Other conditions were the same as in Example 1.

(Comparative Example 8) In Comparative Example 8, lanthanum was used as the additive element M, and manganese was used as the additive element N, a was set to 0.50, b was set to 0.55, c was set to 0.05, d was set to 0.65, e was set to 0.30, and f was set to 0.05. Other conditions were the same as in Example 1.

(Comparative Example 9) In Comparative Example 9, lanthanum was used as the additive element M, and manganese was used as the additive element N, a was set to 0.10, b was set to 0.65, c was set to 0.15, d was set to 0.65, e was set to 0.30, and f was set to 0.05. Other conditions were the same as in Example 1.

(Comparative Example 10) In Comparative Example 10, lanthanum was used as the additive element M, and manganese was used as the additive element N, a was set to 0.25, b was set to 0.80, c was set to 0.05, d was set to 0.65, e was set to 0.30, and f was set to 0.05. Other conditions were the same as in Example 1.

(Comparative Example 11) In Comparative Example 11, lanthanum was used as the additive element M, and manganese was used as the additive element N, a was set to 0.35, b was set to 0.40, c was set to 0.05, d was set to 0.65, e was set to 0.30, and f was set to 0.05. Other conditions were the same as in Example 1.

(Comparative Example 12) In Comparative Example 12, lanthanum was used as the additive element M, and manganese was used as the additive element N, a was set to 0.30, b was set to 0.65, c was set to 0.05, d was set to 0.80, e was set to 0.25, and f was set to 0.05. Other conditions were the same as in Example 1.

(Comparative Example 13) In Comparative Example 13, lanthanum was used as the additive element M, and manganese was used as the additive element N, a was set to 0.30, b was set to 0.65, c was set to 0.05, d was set to 0.40, e was set to 0.40, and f was set to 0.05. Other conditions were the same as in Example 1.

(Comparative Example 14) In Comparative Example 8, lanthanum was used as the additive element M, and manganese was used as the additive element N, a was set to 0.30, b was set to 0.65, c was set to 0.05, d was set to 0.55, e was set to 0.50, and f was set to 0.05. Other conditions were the same as in Example 1.

(Comparative Example 15) In Comparative Example 15, lanthanum was used as the additive element M, and manganese was used as the additive element N, a was set to 0.30, b was set to 0.65, c was set to 0.05, d was set to 0.65, e was set to 0.20, and f was set to 0.05. Other conditions were the same as in Example 1.

For each sample of Examples 9 to 17 and Comparative Examples 8 to 15, the DC bias characteristics, high-temperature load life, and temperature characteristics of the dielectric constant were measured in the same manner as in Examples 1 to 8 and Comparative Examples 1 to 7.

The results are shown in Table 2.

TABLE 2

| | | | | | | | | | | HIGH | TEMPERA- |
|---|---|---|---|---|---|---|---|---|---|---|---|
| | | | | | | | | | DC BIAS | TEMPERATURE | TURE |
| | | | | | | | | | CHARACTER- | LOAD | CHARACTER- |
| | a | b | c | M | d | e | f | N | ISTICS | LIFE | ISTICS |
| EXAMPLE 9 | 0.30 | 0.65 | 0.05 | La | 0.65 | 0.30 | 0.05 | Mn | ⊚ | ⊚ | ⊚ |
| EXAMPLE 10 | 0.40 | 0.60 | 0.05 | La | 0.65 | 0.30 | 0.05 | Mn | Δ | ⊚ | ⊚ |
| EXAMPLE 11 | 0.20 | 0.65 | 0.05 | La | 0.65 | 0.30 | 0.05 | Mn | Δ | ⊚ | ⊚ |
| EXAMPLE 12 | 0.25 | 0.70 | 0.05 | La | 0.65 | 0.30 | 0.05 | Mn | Δ | ⊚ | ⊚ |
| EXAMPLE 13 | 0.35 | 0.50 | 0.05 | La | 0.65 | 0.30 | 0.05 | Mn | Δ | ⊚ | ⊚ |
| EXAMPLE 14 | 0.30 | 0.65 | 0.05 | La | 0.70 | 0.30 | 0.05 | Mn | Δ | ⊚ | ◯ |
| EXAMPLE 15 | 0.30 | 0.65 | 0.05 | La | 0.50 | 0.40 | 0.05 | Mn | Δ | ⊚ | ⊚ |
| EXAMPLE 16 | 0.30 | 0.65 | 0.05 | La | 0.55 | 0.45 | 0.05 | Mn | Δ | ⊚ | ⊚ |
| EXAMPLE 17 | 0.30 | 0.65 | 0.05 | La | 0.65 | 0.25 | 0.05 | Mn | Δ | ⊚ | ◯ |
| COMPARATIVE | 0.50 | 0.55 | 0.05 | La | 0.65 | 0.30 | 0.05 | Mn | X | ⊚ | ⊚ |
| EXAMMPLE 8 | | | | | | | | | | | |
| COMPARATIVE | 0.10 | 0.65 | 0.15 | La | 0.65 | 0.30 | 0.05 | Mn | X | ⊚ | ⊚ |
| EXAMMPLE 9 | | | | | | | | | | | |
| COMPARATIVE | 0.25 | 0.80 | 0.05 | La | 0.65 | 0.30 | 0.05 | Mn | X | ⊚ | ⊚ |
| EXAMMPLE 10 | | | | | | | | | | | |
| COMPARATIVE | 0.35 | 0.40 | 0.05 | La | 0.65 | 0.30 | 0.05 | Mn | X | ⊚ | ⊚ |
| EXAMMPLE 11 | | | | | | | | | | | |
| COMPARATIVE | 0.30 | 0.65 | 0.05 | La | 0.80 | 0.25 | 0.05 | Mn | X | ⊚ | X |
| EXAMMPLE 12 | | | | | | | | | | | |
| COMPARATIVE | 0.30 | 0.65 | 0.05 | La | 0.40 | 0.40 | 0.05 | Mn | X | ⊚ | ⊚ |
| EXAMMPLE 13 | | | | | | | | | | | |
| COMPARATIVE | 0.30 | 0.65 | 0.05 | La | 0.55 | 0.50 | 0.05 | Mn | X | ⊚ | ⊚ |
| EXAMMPLE 14 | | | | | | | | | | | |
| COMPARATIVE | 0.30 | 0.65 | 0.05 | La | 0.65 | 0.20 | 0.05 | Mn | X | ⊚ | X |
| EXAMMPLE 15 | | | | | | | | | | | |

Examples 9 to 17 were not judged as unacceptable (×) in any of the DC bias characteristics, high-temperature load life, or temperature characteristics. This is thought to be because the dielectric layer uses a dielectric ceramic composition as its main ceramic component, which is represented as (BiₐNa_{b}M_{c})(Ti_{d}NbₑN_{f})O₃, where the additive element M is at least one selected from La, Ce, Pr, Nd, Sm, Eu, Gd, Tb, Dy, Ho, Yb, Y, Bi, Ba, Sr, Mg, or Ca, and the additive element N is at least one selected from Mn, V, Fe, W, and Mo, and which satisfies the following conditions: 0.1<a<0.5, 0.4<b<0.8, 0<c≤0.2, 0.4<d<0.8, 0.2<e<0.5, 0<f≤0.1, 0.90≤a+b+c≤1.05, and 0.90≤d+e+f≤1.05.

However, comparing the results of Examples 9 to 17 with those of Comparative Examples 8 to 15, it is thought that deviations from the desired composition ratios of 0.1<a<0.5, 0.4<b<0.8, 0.4<d<0.8, and 0.2<e<0.5 result in a decrease in dielectric constant and poorer DC bias characteristics. In Examples 14 and 17, the temperature characteristics decreased, likely due to increased ferroelectricity. This indicates that a Ti-rich Ti/Nb ratio increases ferroelectricity. In Comparative Examples 8 to 15, deviations from the composition ratios of 0.1<a<0.5, 0.4<b<0.8, 0.4<d<0.8, and 0.2<e<0.5 likely resulted in a significant decrease in dielectric constant and the judgement of the DC bias characteristics as unacceptable. In Comparative Examples 12 and 15, the Ti/Nb ratio became even more Ti-rich, which likely increased ferroelectricity and resulted in the judgement of the temperature characteristics as unacceptable. From the above results, it can be seen that the values of a, b, c, and d are more preferably 0.2<a<0.4, 0.5<b<0.7, 0.5<d<0.7, and 0.25<e<0.45.

Although the embodiments of the present invention have been described in detail, it is to be understood that the various changes, substitutions, and alterations could be made hereto without departing from the spirit and scope of the invention.

What is claimed is:

1. A multilayer ceramic electronic device comprising:
a dielectric layer of which a main component is a dielectric ceramic composition represented by a formula (BiₐNa_{b}M_{c})(Ti_{d}NbₑN_{f})O₃, where M is at least one element selected from La, Ce, Pr, Nd, Sm, Eu, Gd, Tb, Dy, Ho, Yb, Y, Bi, Ba, Sr, Mg, and Ca, and N is at least one element selected from Mn, V, Fe, W, and Mo; and where following conditions are satisfied: 0.1<a<0.5; 0.4<b<0.8; 0<c≤0.2; 0.4<d<0.8; 0.2<e<0.5; 0<f≤0.1; 0.90≤a+b+c≤1.05; and 0.90≤d+e+f≤1.05;
a plurality of internal electrode layers sandwiching the dielectric layer and facing each other; and
a plurality of external electrodes, each of which is electrically connected to teach of the plurality of internal electrode layers.

2. The multilayer ceramic electronic device as claimed in claim 1,
wherein the dielectric ceramic composition satisfies 0<c≤0.1 and 0<f≤0.5.

3. The multilayer ceramic electronic device as claimed in claim 1,
wherein the dielectric ceramic composition satisfies 0.2<a<0.4, 0.5<b<0.7, 0<c≤0.05, 0.5<d<0.7, 0.25<e<0.45 and 0<f≤0.05.

4. The multilayer ceramic electronic device as claimed in claim 1,
wherein an average grain size of dielectric grains represented by the formula (BiₐNa_{b}M_{c})(Ti_{d}NbₑN_{f})O₃ is 0.05 μm or more and 10 μm or less.

5. A dielectric ceramic composition comprising:
a material represented by a formula (BiₐNa_{b}M_{c})(TiₐNbₑN_{f})O₃, where M is at least one element selected from La, Ce, Pr, Nd, Sm, Eu, Gd, Tb, Dy, Ho, Yb, Y, Bi, Ba, Sr, Mg, and Ca, and N is at least one element selected from Mn, V, Fe, W, and Mo, and where following conditions are satisfied: 0.1<a<0.5; 0.4<b<0.8; 0<c≤0.2; 0.4<d<0.8; 0.2<e<0.5; 0<f≤0.1; 0.90≤a+b+c≤1.05; and 0.90≤d+e+f≤1.05.
